(19) United States
(12) Patent Application Publication
(10) Pub. No.: US 2025/0298351 A1
(43) Pub. Date: Sep. 25, 2025

(54) POST-PROCESSING DEVICE AND IMAGE FORMING SYSTEM

(71) Applicant: Fujifilm Business Innovation Corp., Tokyo (JP)

(72) Inventors: Daisuke KUWABARA, Kanagawa (JP); Shoya Kinoshita, Kanagawa (JP); Soma Hashimoto, Kanagawa (JP); Naoto Hamabata, Kanagawa (JP); Mitsuhiro Matsumoto, Kanagawa (JP); Seigo Shinozaki, Kanagawa (JP)

(73) Assignee: FUJIFILM Business Innovation Corp., Tokyo (JP)

(21) Appl. No.: 18/770,127

(22) Filed: Jul. 11, 2024

(30) Foreign Application Priority Data
Mar. 25, 2024 (JP) 2024-048752

(51) Int. Cl. G03G 15/20

(52) U.S. Cl. CPC G03G 15/2064; G03G 15/2053; G03G 2215/0054; G03G 2215/00679

(57) ABSTRACT

A post-processing device includes a post-processing unit that performs post-processing on a recording medium on which a toner image has been formed, and a gloss fixing unit that is arranged in an up-down direction with respect to the post-processing unit, and that applies heat and pressure to the recording medium to impart glossiness to the toner image.

### CROSS-REFERENCE TO RELATED APPLICATIONS

This application is based on and claims priority under 35 USC 119 from Japanese Patent Application No. 2024-048752 filed Mar. 25, 2024.

### BACKGROUND

### (i) Technical Field

The present invention relates to a post-processing device and an image forming system.

### (ii) Related Art

JP2005-242229A describes an image forming apparatus including an image forming unit that forms a toner image using a toner on a recording surface of a recording material, a first fixing unit that performs a process of applying a pressure to the recording surface of the recording material while heating the recording surface of the recording material, on which the toner image has been formed by the image forming unit, to a temperature at which the toner is put into a molten state, a cutting unit that cuts the recording material that has been subjected to the process by the first fixing unit, and a second fixing unit that applies a pressure to the recording surface of the recording material that has been cut by the cutting unit while heating the recording surface of the recording material to the temperature at which the toner is put into a molten state, while conveying the recording material using a surface-smooth belt member, and then cools the recording material while being in a state of closely attached to a fixing belt.

### SUMMARY

There is a post-processing device that imparts glossiness to a toner image formed on a recording medium. The post-processing device includes a post-processing unit such as a cutting process unit that cuts edges and a gloss fixing unit that imparts glossiness to the toner image.

Conventionally, the post-processing unit and the gloss fixing unit are arranged in a width direction of the device as viewed by the user facing the front of the device. Therefore, the post-processing device has increased in size in the width direction.

Aspects of non-limiting embodiments of the present disclosure relate to a post-processing device and an image forming system that suppress an increase in size of the post-processing device in a width direction as compared with a case where a post-processing unit and a gloss fixing unit are arranged in the width direction.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a post-processing device including: a post-processing unit that performs post-processing on a recording medium on which a toner image has been formed; and a gloss fixing unit that is arranged in an up-down direction with respect to the post-processing unit, and applies heat and pressure to the recording medium to impart glossiness to the toner image.

### BRIEF DESCRIPTION OF THE DRAWINGS

Exemplary embodiment(s) of the present invention will be described in detail based on the following figures, wherein:

FIG. 1 is a schematic configuration diagram showing an image forming system according to an exemplary embodiment of the present disclosure;

FIG. 2 is a side view showing a post-processing device according to the exemplary embodiment of the present disclosure;

FIG. 3 is a plan view showing a cutting process unit of the post-processing device according to the exemplary embodiment of the present disclosure; and

FIG. 4 is a configuration diagram showing a gloss fixing unit of the post-processing device according to the exemplary embodiment of the present disclosure.

### DETAILED DESCRIPTION

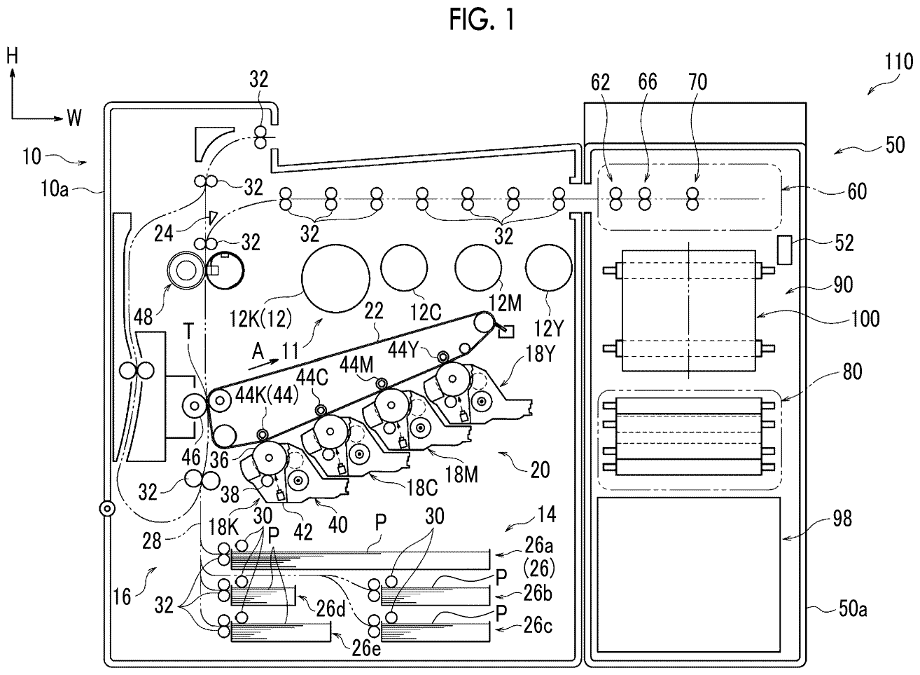

Examples of a post-processing device and an image forming system according to an exemplary embodiment of the present invention will be described with reference to FIGS. 1 to 4. An arrow H shown in each drawing indicates a vertical direction and an up-down direction of an apparatus, an arrow W is orthogonal to the arrow H and indicates a horizontal direction and a width direction of the apparatus, and an arrow D is orthogonal to the arrow H and the arrow W and indicates the horizontal direction and a depth direction of the apparatus.

### Overall Configuration of Image Forming System 110

As shown in FIG. 1, an image forming system 110 includes an image forming apparatus 10 and a post-processing device 50. The image forming apparatus 10 is an apparatus that forms a toner image on a recording medium P through an electrophotographic method, and the post-processing device 50 is a device that removes a margin part of an edge of the recording medium P on which the toner image has been formed by the image forming apparatus 10 and that imparts glossiness to the toner image. The so-called post-processing device is a device for obtaining a photo print image without margins.

The image forming apparatus 10 and the post-processing device 50 are arranged in this order from one side to the other side in the width direction. Here, the width direction is a left-right direction with respect to a user in a state in which the user stands in front of the apparatus.

### Image Forming Apparatus 10

As shown in FIG. 1, the image forming apparatus 10 includes a medium accommodating unit 14 in which the recording medium P is accommodated, a conveying unit 16 that conveys the recording medium P accommodated in the medium accommodating unit 14, and an image forming unit 20 that forms an image on the recording medium P conveyed from the medium accommodating unit 14 by the conveying unit 16. Further, the image forming apparatus 10 includes a toner accommodating unit 11 that accommodates a toner. The medium accommodating unit 14, the conveying unit 16, the image forming unit 20, and the toner accommodating unit 11 are arranged in this order from a lower side to an upper side.

### Medium Accommodating Unit 14

As shown in FIG. 1, the medium accommodating unit 14 includes a plurality of accommodating members 26 that can be pulled out from an apparatus body 10a of the image forming apparatus 10 toward a front side in the depth direction, and a feeding roller 30 that feeds the recording medium P loaded in the accommodating member 26 to a conveying path 28. In the present exemplary embodiment, five accommodating members 26a to 26e are provided. The accommodating members 26d and 26e are loaded with photo paper for outputting a photo. The accommodating members 26a to 26c are loaded with standard plain paper such as A4 size or A3 size.

### Conveying Unit 16

As shown in FIG. 1, the conveying unit 16 includes a plurality of conveying rollers 32 that convey the recording medium P fed by the feeding roller 30 from the accommodating member 26 along the conveying path 28.

### Image Forming Unit 20

As shown in FIG. 1, the image forming unit 20 includes image forming units 18Y, 18M, 18C, and 18K as four forming units for yellow (Y), magenta (M), cyan (C), and black (K). In the following description, in a case where there is no need to distinguish between Y, M, C, and K, Y, M, C, and K may be omitted.

The image forming unit 18 of each color includes an image holding body 36, a charging member 38 that charges a surface of the image holding body 36, and an exposure device 42 that emits exposure light to the image holding body 36. Further, the image forming unit 18 of each color includes a developing device 40 that develops an electrostatic latent image formed by the exposure light emitted from the exposure device 42 to the charged image holding body 36, to visualize the electrostatic latent image as the toner image.

In addition, the image forming unit 20 includes an endless transfer belt 22 that circulates in a direction of an arrow A in the drawing, and a primary transfer roller 44 that transfers the toner image formed by the image forming unit 18 of each color to the transfer belt 22. Further, the image forming unit 20 includes a secondary transfer roller 46 that transfers the toner image transferred to the transfer belt 22 to the recording medium P, and a fixing device 48 that applies heat and pressure to the recording medium P, to which the toner image has been transferred, to fix the toner image to the recording medium P.

### Toner Accommodating Unit 11

As shown in FIG. 1, the toner accommodating unit 11 includes an accommodating member 12Y that accommodates a yellow (Y) toner, an accommodating member 12M that accommodates a magenta (M) toner, an accommodating member 12C that accommodates a cyan (C) toner, and an accommodating member 12K that accommodates a black (K) toner. The accommodating member 12K, the accommodating member 12C, the accommodating member 12M, and the accommodating member 12Y are arranged in this order from one side (left side in the drawing) to the other side (right side in the drawing) in the width direction. Further, the capacity of the accommodating member 12K accommodating the black toner that is used in a large amount is larger than the capacities of the other accommodating members 12.

### Action of Image Forming Apparatus

With the image forming apparatus 10, an image is formed as follows.

First, the charging member 38 of each color, to which a voltage has been applied, uniformly negatively charges the surface of the image holding body 36 of each color at a predetermined potential. Subsequently, based on image data input from the outside, the exposure device 42 of each color emits the exposure light to the charged surface of the image holding body 36 of each color to form the electrostatic latent image.

Consequently, the electrostatic latent image corresponding to the image data is formed on the surface of the image holding body 36 of each color. Further, the developing device 40 of each color develops this electrostatic latent image and visualizes the electrostatic latent image as the toner image. In addition, the primary transfer roller 44 of each color transfers the toner image formed on the surface of the image holding body 36 of each color to the transfer belt 22.

Therefore, the recording medium P fed to the conveying path 28 by the feeding roller 30 from any of the accommodating members 26 is fed to a transfer position T where the transfer belt 22 and the secondary transfer roller 46 come into contact with each other. At the transfer position T, the recording medium P is conveyed between the transfer belt 22 and the secondary transfer roller 46, so that the toner image on the surface of the transfer belt 22 is transferred to the recording medium P.

The toner image transferred to the recording medium P is fixed to the recording medium P by the fixing device 48. The recording medium P on which the toner image has been fixed is sorted by a sorting member 24. For example, in a case where the recording medium P is plain paper, the recording medium P is discharged to the outside of the apparatus body 10a. Meanwhile, in a case where the recording medium P is a photo paper, the recording medium P is conveyed from one side to the other side in the width direction by a conveying roller 32 and is fed to the post-processing device 50.

Here, in a case where the toner image formed on the transfer belt 22 is transferred to the recording medium P, in order to prevent the toner from adhering to the secondary transfer roller 46, a margin portion is provided on four edges of the recording medium P.

### Post-Processing Device 50

Next, the post-processing device 50 will be described.

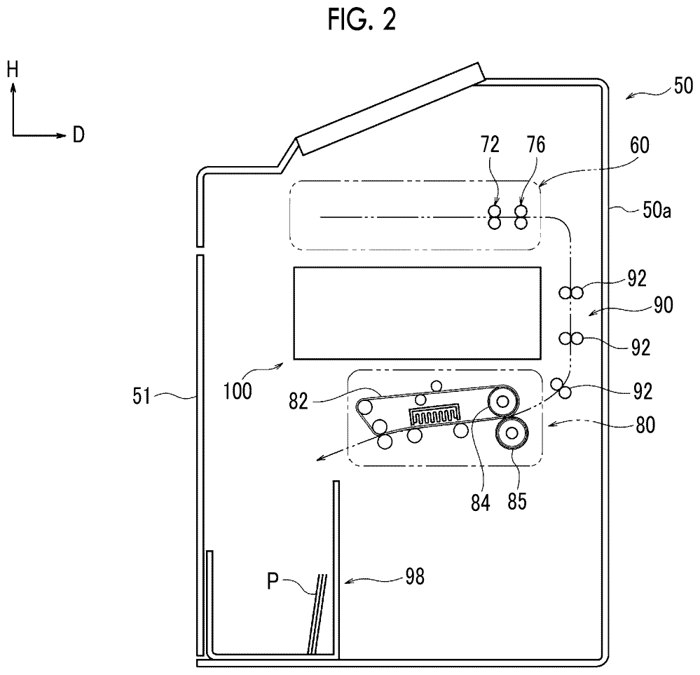

As shown in FIGS. 1 and 2, the post-processing device 50 includes a cutting process unit 60 that cuts and removes the margin portions provided at the four edges of the recording medium P, a gloss fixing unit 80 that imparts glossiness to the toner image formed on the recording medium P, and a conveying unit 90 that conveys the recording medium P. Further, the post-processing device 50 includes a collection box 100 that collects the margin portions removed by the cutting process unit 60, and a discharge unit 98 to which the recording medium P is discharged. Each of these units is provided inside a device body 50a.

The cutting process unit 60, the collection box 100, the gloss fixing unit 80, and the discharge unit 98 are arranged in this order from an upper side to a lower side in the up-down direction. In addition, the conveying unit 90 is disposed on a rear side with respect to the cutting process unit 60, the collection box 100, and the gloss fixing unit 80 in the depth direction. Further, the discharge unit 98 is disposed on a front side with respect to the gloss fixing unit 80 in the depth direction. Here, the depth direction is a depth direction with respect to the user in a state in which the user stands in front of the device.

### Cutting Process Unit 60

As shown in FIGS. 1 and 2, the cutting process unit 60 is disposed such that the recording medium P on which the toner image has been formed by the image forming apparatus 10 is received from one side in the width direction. The cutting process unit 60 is an example of a post-processing unit.

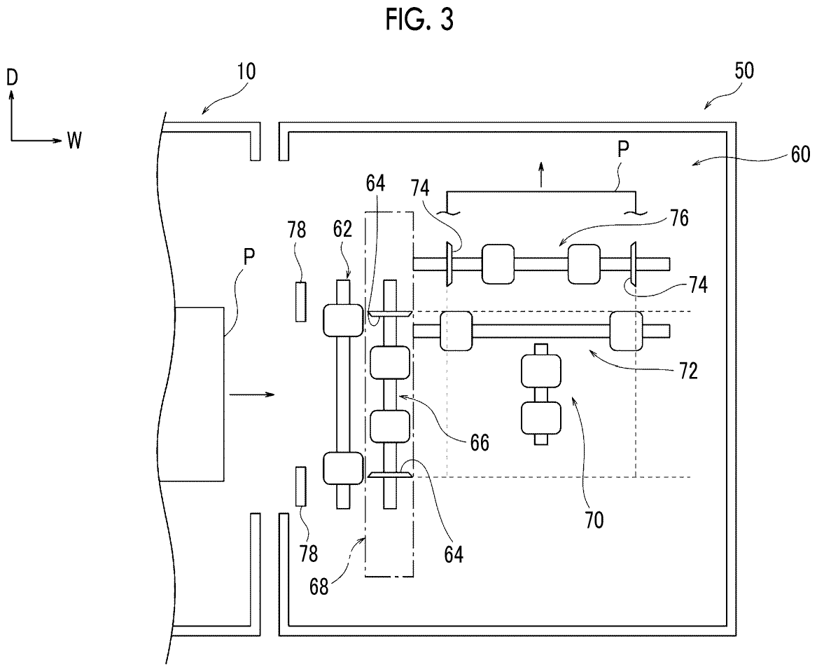

As shown in FIG. 3, the cutting process unit 60 includes a conveying roller 62 that receives, from the image forming apparatus 10, the recording medium P conveyed in the width direction without changing a conveyance direction of the recording medium P (hereinafter, referred to as a “medium conveyance direction”), a pair of first cutters 64 that cut the margin portions of the recording medium P conveyed by the conveying roller 62 while rotating, and a conveying roller 66 that includes a shaft portion to which the first cutters 64 are attached and that applies a conveying force in the width direction to the recording medium P whose margin portions are to be cut.

In addition, the cutting process unit 60 is configured to integrally move the first cutters 64 and the conveying roller 66 in an axial direction and includes a cutting position adjustment mechanism 68 that adjusts a cutting position.

Further, in the medium conveyance direction, a conveying roller 70 that conveys, in the width direction, the recording medium P whose margin portions have been cut by the first cutters 64 and that determines the position of the recording medium P in the width direction is disposed downstream of the cutting position adjustment mechanism 68. The conveying roller 70 comes into contact with the recording medium P in a case where the recording medium Pis conveyed in the width direction, and is separated from the recording medium P in a case where the recording medium P is conveyed to the rear side in the depth direction.

Further, the cutting process unit 60 includes a conveying roller 72 for conveying the recording medium P to the rear side in the depth direction, a pair of second cutters 74 that cut the margin portions of the recording medium P conveyed to the rear side in the depth direction by the conveying roller 72 while rotating, and a conveying roller 76 that includes a shaft portion to which the second cutters 74 are attached and that applies a conveying force in the depth direction to the recording medium P whose margin portions are to be cut. The conveying roller 72 is separated from the recording medium P in a case where the recording medium P is conveyed in the width direction, and comes into contact with the recording medium P in a case where the recording medium P is conveyed to the rear side in the depth direction.

Further, the cutting position is adjusted by detecting a cut end part of a fixed image using a cutting position detection sensor 78 disposed upstream of the conveying roller 62 in the medium conveyance direction. The cutting position detection sensor 78 is disposed on an IN side (the front side of the device) and an OUT side (the rear side of the device) on which image/non-image areas can be discriminated before the recording medium P enters a cutting mechanism.

In this configuration, the recording medium P supplied from the image forming apparatus 10 is conveyed in the width direction by the conveying roller 62. Specifically, in a case where a sensor (not shown) or the like detects that a leading end of the recording medium P has reached, for example, the vicinity of the conveying roller 62, the conveying roller 70 is put into an abutting state of abutting against the recording medium P, and the conveying roller 72 is put into a separated state of being separated from the recording medium P. In addition, the conveying roller 62, the conveying roller 66, the conveying roller 70, and the first cutters 64 rotate to convey the recording medium P in the width direction. Then, the margin portions of the recording medium P passing through the first cutters 64 are cut while being conveyed by the first cutters 64. The cut margin portions slide on a slope (not shown) and are collected into the collection box 100 (refer to FIG. 2).

After that, in the cutting process unit 60, the conveyance of the recording medium Pis temporarily stopped at a predetermined position. In addition, in the cutting process unit 60, the conveying roller 70 is put into a separated state of being separated from the recording medium P, and the conveying roller 72 is put into a contact state of being in contact with the recording medium P. Further, the conveying roller 72, the conveying roller 76, and the second cutters 74 rotate to convey the recording medium P to the rear side in the depth direction. Then, the margin portions of the recording medium P passing through the second cutters 74 are cut while being conveyed by the second cutters 74. The cut margin portions slide on the slope (not shown) and are collected into the collection box 100 (refer to FIG. 2).

### Conveying Unit 90

As shown in FIG. 2, the conveying unit 90 includes a plurality of conveying rollers 92 that receive the recording medium P fed by the cutting process unit 60 and that convey the recording medium P toward the gloss fixing unit 80. The axial direction of the plurality of conveying rollers 92 is set as the width direction, and the plurality of conveying rollers 92 are disposed on the rear side of the collection box 100 in the depth direction.

### Collection Box 100

As shown in FIGS. 1 and 2, the collection box 100 is disposed between the cutting process unit 60 and the gloss fixing unit 80 in the up-down direction and on the front side of the conveying unit 90 in the depth direction. The collection box 100 is an example of an attachable and detachable unit.

Meanwhile, the post-processing device 50 includes a maintenance door 51 through which an interior of the post-processing device 50 is opened from the front side in the depth direction and that is provided on the device body 50a of the post-processing device 50. In a case where the interior of the device body 50a is opened by the maintenance door 51, the collection box 100 is attached and detached with respect to the device body 50a from the front side in the depth direction. The device body 50a is an example of a body.

### Gloss Fixing Unit 80

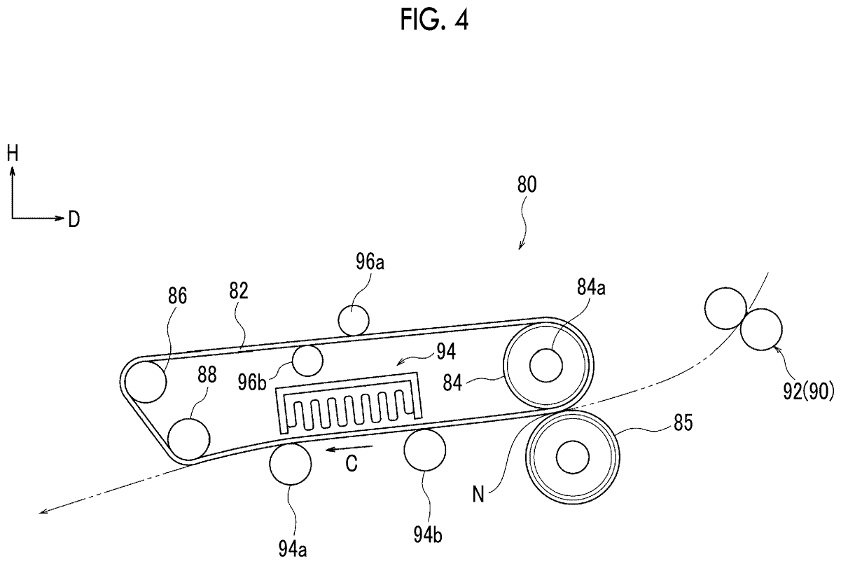

As shown in FIG. 4, the gloss fixing unit 80 includes an endless fixing belt 82, a heating roller 84 on which the fixing belt 82 is wound, a peeling roller 88, and a control roller 86 that controls a walk. The heating roller 84 rotatably supports the fixing belt 82 and includes a halogen lamp 84a that heats a certain region of a nip portion N and that is provided in a hollow part of an inside of the heating roller 84.

Further, the gloss fixing unit 80 includes a pressure roller 85 that is in pressure contact with the heating roller 84 with the fixing belt 82 sandwiched therebetween to form the nip portion N. The heating roller 84 is rotationally driven by a driving force (not shown), so that the fixing belt 82 is configured to circulate in a direction of an arrow C in the drawing.

In addition, a heat sink 94 that forcibly cools the recording medium P closely attached to the fixing belt 82 is provided on an inner side of the fixing belt 82. The heat sink 94 is cooled by a cooling fan (not shown). In order to assist in ensuring the close attachment between the conveyed recording medium P and the fixing belt 82, biasing rollers 94a and 94b that bias the recording medium P toward the fixing belt 82 are provided at positions facing the heat sink 94 with the fixing belt 82 sandwiched therebetween. In addition, small-diameter tension rollers 96a and 96b that apply a constant tension to the fixing belt 82 are disposed between the control roller 86 and the heating roller 84.

In this configuration, the recording medium P conveyed by the conveying unit 90 enters the nip portion N. In the nip portion N, the toner constituting the toner image is substantially heated to about 120° C. to 150° C. by the heat from the halogen lamp 84a and the pressure from the pressure roller 85 and melted, and the toner image is buried in an image-receiving layer of the recording medium P softened by the heat. After that, even after passing through the nip portion N, the recording medium P is conveyed in a state of being closely attached to the fixing belt 82. During this conveyance, the recording medium P is forcibly cooled by the heat sink 94, the smoothness of the surface of the fixing belt 82 is transferred to the surface of the recording medium P, that is, the image-receiving layer, and the surface of the recording medium P and the toner image obtain glossiness.

Further, the recording medium P cooled and conveyed by the fixing belt 82 is peeled from the fixing belt 82 by the waist (rigidity) of the recording medium P at a portion of the peeling roller 88 that has been cooled to a temperature (for example, to about 40° C. to 80° C.) equal to or lower than the melting temperature of the toner in the vicinity of the peeling roller 88. Further, the recording medium P peeled from the fixing belt 82 is discharged to the discharge unit 98 shown in FIG. 2.

Here, in the gloss fixing unit 80, a process speed should be made lower than a process speed of the image forming apparatus 10 such that the toner is put into a molten state, in order to impart glossiness to the toner image formed on the recording medium P.

### Discharge Unit 98

As shown in FIG. 1, the discharge unit 98 is arranged in the up-down direction with respect to the cutting process unit 60 and the gloss fixing unit 80 as viewed from the depth direction. Further, as shown in FIG. 2, the discharge unit 98 is disposed in a portion on the front side in the depth direction with respect to the gloss fixing unit 80.

In a case where the interior of the device body 50a is opened by the maintenance door 51, the recording medium P discharged to the discharge unit 98 can be taken out from the device body 50a.

### Others

Next, a control unit 52 (refer to FIG. 1) provided in the post-processing device 50 will be described. As described above, in the gloss fixing unit 80, the process speed should be made lower than the process speed of the image forming apparatus 10, in order to impart glossiness to the toner image formed on the recording medium P. In response, the control unit 52 controls the rotation speed of the conveying roller 92 of the conveying unit 90 to gradually decrease (slow down) the conveying speed of the recording medium P until the recording medium P reaches the gloss fixing unit 80.

### SUMMARY

As described above, in the post-processing device 50, the cutting process unit 60 and the gloss fixing unit 80 are arranged in the up-down direction. As a result, an increase in size of the post-processing device 50 in the width direction is suppressed as compared with a case where the cutting process unit and the gloss fixing unit are arranged in the width direction.

In addition, in the post-processing device 50, the conveying unit 90 is disposed on the rear side in the depth direction with respect to the cutting process unit 60 and the gloss fixing unit 80. As a result, an increase in size of the post-processing device 50 in the width direction is suppressed as compared with a case where the conveying unit is disposed on one side or the other side in the width direction with respect to the cutting process unit and the gloss fixing unit.

In addition, in the post-processing device 50, the conveying unit 90 is disposed on the rear side in the depth direction with respect to the cutting process unit 60 and the gloss fixing unit 80. As a result, a conveyance sound heard by the user is reduced as compared with a case where the conveying unit is disposed on the front side in the depth direction with respect to the cutting process unit and the gloss fixing unit.

In addition, in the post-processing device 50, the collection box 100 that is attachable and detachable with respect to the device body 50a from the front side in the depth direction is disposed between the cutting process unit 60 and the gloss fixing unit 80 in the up-down direction and on the front side in the depth direction with respect to the conveying unit 90. As a result, the collection box 100 is easily attached and detached as compared with a case where the conveying unit is disposed on the front side in the depth direction.

In addition, in the post-processing device 50, the discharge unit 98 is arranged in the depth direction with respect to the gloss fixing unit 80. As a result, an increase in size of the post-processing device in the width direction is suppressed as compared with a case where the discharge unit is disposed on one side or the other side in the width direction with respect to the gloss fixing unit.

Additionally, in the post-processing device 50, the discharge unit 98 is disposed on the front side in the depth direction with respect to the gloss fixing unit 80. Further, in a case where the interior of the device body 50a is opened by the maintenance door 51, the recording medium P discharged to the discharge unit 98 can be taken out from the device body 50a. As a result, the user can easily take out the recording medium P from the discharge unit 98 as compared with a case where the discharge unit is disposed on the rear side in the depth direction with respect to the gloss fixing unit.

In addition, the image forming system 110 includes the post-processing device 50. As a result, an increase in size of the image forming system 110 in the width direction is suppressed as compared with a case where the post-processing device in which the cutting process unit and the gloss fixing unit are arranged in the width direction is provided.

Moreover, in the image forming system 110, the cutting process unit 60 receives the recording medium P on which the toner image has been formed from the width direction and feeds the received recording medium P in the depth direction. As a result, the recording medium P is easily received by disposing the post-processing device 50 in the width direction of the image forming apparatus 10 that discharges the recording medium P in the width direction, as compared with a case where the direction in which the cutting process unit receives the recording medium and the direction in which the cutting process unit feeds the recording medium are the same (not bent).

Although a specific exemplary embodiment of the present disclosure has been described in detail, the exemplary embodiment of the present disclosure is not limited to such an exemplary embodiment, and as is apparent to a person skilled in the art, the present disclosure can employ various other exemplary embodiments within the scope of the present disclosure. For example, in the above-described exemplary embodiment, the cutting process unit 60 has been described as the post-processing unit, but for example, the post-processing unit may be a punch unit that forms a hole in the recording medium P, or the like.

In addition, in the above-described exemplary embodiment, the collection box 100 that is attachable and detachable with respect to the device body 50a is disposed between the cutting process unit 60 and the gloss fixing unit 80 in the up-down direction, but for example, a storage box that stores a manual or the like may be disposed as the attachable and detachable unit.

Additionally, in the above-described exemplary embodiment, the conveying unit 90 is disposed in the depth direction with respect to the cutting process unit 60 and the gloss fixing unit 80, but may be disposed on one side or the other side in the width direction with respect to the cutting process unit and the gloss fixing unit. However, in this case, the action achieved by being disposed in the depth direction is not achieved.

Further, in the above-described exemplary embodiment, the discharge unit 98 is arranged in the depth direction with respect to the gloss fixing unit 80, but may be arranged in the width direction with respect to the gloss fixing unit. However, in this case, the action achieved by being arranged in the depth direction is not achieved.

(((1)))

A post-processing device comprising:
a post-processing unit that performs post-processing on a recording medium on which a toner image has been formed; and
a gloss fixing unit that is arranged in an up-down direction with respect to the post-processing unit, and applies heat and pressure to the recording medium to impart glossiness to the toner image.
   (((2)))

The post-processing device according to (((1))), further comprising:
a conveying unit that conveys the recording medium between the post-processing unit and the gloss fixing unit and is disposed on a rear side or a front side in a depth direction with respect to the post-processing unit and the gloss fixing unit.
   (((3)))

The post-processing device according to (((1))) or (((2))),
wherein the conveying unit is disposed on the rear side in the depth direction.
   (((4)))

The post-processing device according to any one of (((1))) to (3)),
wherein an attachable and detachable unit that is attachable and detachable with respect to a body from the front side in the depth direction is disposed between the post-processing unit and the gloss fixing unit in the up-down direction.
   (((5)))

The post-processing device according to any one of (((1))) to (((4))), further comprising:
a discharge unit that is arranged in a depth direction with respect to the gloss fixing unit and to which the recording medium is discharged.
   (((6)))

The post-processing device according to (((5))),
wherein the discharge unit is disposed on a front side in the depth direction with respect to the gloss fixing unit, and
the discharge unit is opened toward the front side in the depth direction.
   (((7)))

An image forming system comprising:
an image forming apparatus that forms a toner image on a recording medium; and
the post-processing device according to any one of (((1))) to (((6))).
   (((8)))

An image forming system comprising:
an image forming apparatus that forms a toner image on a recording medium; and
the post-processing device according to any one of (((2))) to (((4)) including a post-processing unit that receives the recording medium, on which the toner image has been formed by the image forming apparatus, in a width direction and that feeds the received recording medium in a depth direction.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A post-processing device comprising:
a post-processing unit that performs post-processing on a recording medium on which a toner image has been formed; and
a gloss fixing unit that is arranged in an up-down direction with respect to the post-processing unit, and applies heat and pressure to the recording medium to impart glossiness to the toner image.

2. The post-processing device according to claim 1, further comprising:
a conveying unit that conveys the recording medium between the post-processing unit and the gloss fixing unit and is disposed on a rear side or a front side in a depth direction with respect to the post-processing unit and the gloss fixing unit.

3. The post-processing device according to claim 2,
wherein the conveying unit is disposed on the rear side in the depth direction.

4. The post-processing device according to claim 3,
wherein an attachable and detachable unit that is attachable and detachable with respect to a body from the front side in the depth direction is disposed between the post-processing unit and the gloss fixing unit in the up-down direction.

5. The post-processing device according to claim 1, further comprising:
a discharge unit that is arranged in a depth direction with respect to the gloss fixing unit and to which the recording medium is discharged.

6. The post-processing device according to claim 5,
wherein the discharge unit is disposed on a front side in the depth direction with respect to the gloss fixing unit, and
the discharge unit is opened toward the front side in the depth direction.

7. An image forming system comprising:
an image forming apparatus that forms a toner image on a recording medium; and
the post-processing device according to claim 1.

8. An image forming system comprising:
an image forming apparatus that forms a toner image on a recording medium; and
the post-processing device according to claim 2.

9. An image forming system comprising:
an image forming apparatus that forms a toner image on a recording medium; and
the post-processing device according to claim 3.

10. An image forming system comprising:
an image forming apparatus that forms a toner image on a recording medium; and
the post-processing device according to claim 4.

11. An image forming system comprising:
an image forming apparatus that forms a toner image on a recording medium; and
the post-processing device according to claim 5.

12. An image forming system comprising:
an image forming apparatus that forms a toner image on a recording medium; and
the post-processing device according to claim 6.

13. An image forming system comprising:
an image forming apparatus that forms a toner image on a recording medium; and
the post-processing device according to claim 2 including a post-processing unit that receives the recording medium, on which the toner image has been formed by the image forming apparatus, in a width direction and that feeds the received recording medium in a depth direction.

14. An image forming system comprising:
an image forming apparatus that forms a toner image on a recording medium; and
the post-processing device according to claim 3 including a post-processing unit that receives the recording medium, on which the toner image has been formed by the image forming apparatus, in a width direction and that feeds the received recording medium in a depth direction.

15. An image forming system comprising:
an image forming apparatus that forms a toner image on a recording medium; and
the post-processing device according to claim 4 including a post-processing unit that receives the recording medium, on which the toner image has been formed by the image forming apparatus, in a width direction and that feeds the received recording medium in a depth direction.
